(19) United States
(12) Patent Application Publication
(10) Pub. No.: US 2023/0249706 A1
(43) Pub. Date: Aug. 10, 2023

(54) USAGE-BASED RECOMMENDATION LOGIC FOR RETROFITTING A MOTOR VEHICLE WITH A DEVICE

(71) Applicant: AUDI AG, Ingolstadt (DE)

(72) Inventors: John NEWMAN, Ingolstadt (DE); Lorenzo SCHÜRMANN, Ingolstadt (DE); Felix WITTMANN, Ingolstadt (DE)

(73) Assignee: AUDI AG, Ingolstadt (DE)

(21) Appl. No.: 17/999,792

(22) PCT Filed: May 20, 2021
(86) PCT No.: PCT/EP2021/063438

§ 371 Date: Nov. 23, 2022

(30) Foreign Application Priority Data
May 27, 2020 (DE) 10 2020 114 121.1

(51) Int. Cl. B60W 50/14; G07C 5/00

(52) U.S. Cl. CPC B60W 50/14; G07C 5/008; B60W 2050/146

(57) ABSTRACT

The present disclosure relates to a usage-based recommendation logic for retrofitting a motor vehicle with a device, the device being an automatically adjustable exterior mirror. For this purpose, usage-specific, drive-specific, and vehicle-specific data are collected on the motor vehicle, said data relating to the function of the device. The recommendation logic which is connected to the on-board computer system evaluates the usage-specific, drive-specific, and vehicle-specific data using specified thresholds. Optionally, a decision recommendation for retrofitting the motor vehicle with the device is generated from the evaluation and is transmitted to a driver and/or owner.

### TECHNICAL BACKGROUND

The present disclosure relates to a usage-based recommendation logic for retrofitting a motor vehicle with a device, in particular with an automatic mirror adjustment.

### BACKGROUND

When choosing a new motor vehicle to purchase, several attributes and options must be considered. These attributes and options have a direct effect on the purchase price, but sacrificing a certain attribute or a certain equipment option is not final. A motor vehicle can be retrofitted with most options/attributes not initially purchased. These retrofit devices, usually referred to below simply by “device” as a collective term for options/attributes, can be sold not only by the manufacturer of the motor vehicle, but also by other manufacturers. As a result, the motor vehicle manufacturer is missing out on important business.

In addition, a motor vehicle owner can hardly be persuaded to buy a certain device by post-sale advertising. It is crucial that the motor vehicle owner can directly see the benefit of such a device.

Automatically adjustable exterior mirrors are an example of such devices which may be retrofitted. Such automatically adjustable exterior mirrors are known; for example, reference is made to the published patent application DE 10 2009 048 816 A1 entitled “Method for automatically adjusting an exterior mirror”.

An automatically adjustable mirror (exterior mirror, rear-view mirror) is a mirror that is capable of changing the angle to the driver depending on whether the vehicle is moving forwards or backwards, with an additional essential function being to tilt the mirror so that when reversing, the driver can see the position of the vehicle relative to a curb or other obstacle much more easily, thereby avoiding damage to the vehicle or a vehicle part (e.g., wheel rims). One mirror is referred to above, but depending on the vehicle, multiple mirrors can also be provided, such as left, right and/or interior. Below, therefore, the total number of mirrors is always meant.

An automatically adjustable exterior mirror is not simply a “nice-to-have” additional piece of equipment, rather such a mirror makes an important contribution to road safety while driving, in particular on bends, and also contributes to safe parking with as little damage as possible in particularly narrow conditions. The benefit is also particularly evident for drivers with less honed parking skills.

It is also difficult for the motor vehicle manufacturer to target those individuals who are potentially willing to purchase such a retrofit device or product due to a lack of information about which individuals would benefit most from a particular retrofit device.

### BRIEF DESCRIPTION OF DRAWINGS/FIGURES

FIG. 1 shows a block diagram of a recommendation logic.

### DETAILED DESCRIPTION

The object of the present disclosure is based on the fact that there is a need for the motor vehicle manufacturer, as well as for a motor vehicle owner/driver who is open to advice, to specify a means which proposes a retrofit device, the benefit of the retrofit device being determined by the driving behavior of the owner or driver.

This object is achieved by a usage-based recommendation logic having the features of the independent claim. Advantageous embodiments with expedient developments are specified in the dependent claims.

A usage-based recommendation logic for retrofitting a motor vehicle with a device is therefore proposed, the motor vehicle having an on-board computer system to which usage-specific, drive-specific, and vehicle-specific data can be supplied. According to the present disclosure, the usage-specific, drive-specific, and vehicle-specific data relate to the function of the device and sensors connected to the on-board computer system are provided to record this data. The recommendation logic is connected to the on-board computer system and evaluates the usage-specific, drive-specific, and vehicle-specific data using specified thresholds and generates a decision recommendation for retrofitting from the evaluation.

The term usage-specific data means data associated with the specific use of any device or adjustment, for example recording a manual (electrically assisted) adjustment of the rear-view mirrors, where the rear-view mirrors can be adjusted using operating elements from the driver’s cab.

The term drive-specific data includes, for example, all data relating to driving such as location and speed of the motor vehicle, engine power based on location and time stamp, and actuation of control elements of the motor vehicle that have an influence or effect on driving.

The term vehicle-specific data is usually understood to mean a vehicle identification number VIN, which serves as a key for the total number of components and history (e.g., country of manufacture) of a vehicle.

The solution according to the present disclosure has the following advantages, among others. With the generation of a decision recommendation, the present disclosure provides a data-based and thus deterministic indication of how useful it would have been to retrofit the motor vehicle with the device mentioned based on previous driving behavior, if this device had actually been present in a specific situation. The manufacturer can address the drivers or owners in a targeted manner, who can then immediately see the benefit of the device and do not simply suspect a post-sale business division from the manufacturer. This means that there is no need to launch untargeted and ineffective advertising for certain retrofit devices.

Described below are embodiments which primarily relate to a usage-based recommendation logic for retrofitting a motor vehicle with an automatically adjustable exterior mirror or an automatically adjustable mirror system. However, the present disclosure is not limited to retrofitting with an automatically adjustable exterior mirror, but can also be used in a non-exhaustive list, for example, retrofitting/updating the software of the on-board computer with regard to a driving behavior (cruise control) that allows a particularly energy-efficient driving style, taking into account the expected terrain topology and the current vehicle load. As another example, retrofitting/ updating the software of the on-board computer for energy-optimized control of the air conditioning, taking into account rapidly changing outside temperatures resulting from the intended route, e.g., frequent changes of tunnel sections and open sections on alpine pass roads.

Using the usage-based recommendation logic, the usage-specific, drive-specific, and vehicle-specific data can be transmitted wirelessly to an external server system and the recommendation logic can be implemented in the external server system, the decision recommendation generated being transmitted to the motor vehicle and/or to the owner and/or driver of the motor vehicle.

With this embodiment, a log book about the vehicle, which is usually kept anyway, can be supplemented on the server system with important data about the vehicle and its use. The decision recommendation generated can also be transmitted to other parties, for example to branches or service centers of the motor vehicle manufacturer. The transmission to the owner and/or driver is unproblematic under data protection law if the aforementioned persons have agreed to the use of their communication addresses during the purchase and/or during the instruction.

Furthermore, using the usage-based recommendation logic, the recommendation logic can be implemented in the on-board computer, the decision recommendation generated being transmitted to a display in the motor vehicle and/or to the owner and/or driver of the motor vehicle.

This embodiment takes special data protection regulations into account, according to which a person can retain control of their drive-specific data such as location or speed, etc., on the vehicle. The various transmission destinations can be freely combined. Transmission to a person via the on-board WLAN is particularly advantageous, as the context of this decision recommendation is obvious and the decision recommendation is more effective than if this transmission takes place at some later point in time outside of the motor vehicle in question.

Furthermore, using the usage-based recommendation logic, the decision recommendation generated can be transmitted to a mobile device of the vehicle owner or the driver of the motor vehicle in question.

This embodiment allows the person in question to be addressed personally. This embodiment is based on the contact details identifying the person in question, such as an email address or mobile number. These data are often available because the persons in question have initially given consent for their use.

Using the usage-based recommendation logic, the three phases can be provided for the usage-based recommendation logic and/or for the on-board computer system and/or for the external server system are data collection phase, data processing phase with generation of a decision recommendation, and transmission and notification phase.

This embodiment makes it possible to distribute the three phases to the on-board computer, the usage-based recommendation logic and the external server in a modular, needs-based manner and in accordance with data protection requirements.

Furthermore, the usage-based recommendation logic can be provided to retrofit an automatically adjustable exterior mirror, so that in the data collection phase, the usage-specific and drive-specific data relate to the detection of manually set exterior mirror settings and to the recording of the type, number and location of parking operations, and in the data collection phase, the vehicle-specific data relate to the vehicle identification and/or to the presence of low-profile tires.

This embodiment makes it possible to transmit a decision recommendation for retrofitting with an automatically adjustable exterior mirror, which recommendation is based on real driving behavior and thus unequivocally documents the usefulness of such a retrofit, to a driver or owner of a motor vehicle. Checking for the presence (this is also a threshold) of low-profile tires means that if they are absent, no decision recommendation is generated, since the potential for damage to the wheels or rims when parking is extremely low if there are no low-profile tires. It should be noted that most motor vehicles are configured to accommodate low-profile tires, among other things by taking into account the clearance height between the road and the underside of the vehicle, this information is therefore usually accessible via the vehicle identification number VIN.

Using the usage-based recommendation logic, in the data collection phase, the drive-specific data can relate to a recording of sounds associated with wheel rim scratches on a curb, time stamps being added to this recording.

This embodiment makes it possible to show a driver or owner of a motor vehicle the damage potential and/or the actual damage caused by the absence of an automatically adjustable exterior mirror. However, this requires that the vehicle in question is fitted with low-profile tires.

Furthermore, using the usage-based recommendation logic, a decision recommendation for retrofitting the motor vehicle with a heatable, automatically adjustable exterior mirror can be generated.

This embodiment is based on the recorded drive-specific data, such as the location, temperature and duration of such an exposure. The term drive-specific also includes the standstill or the parking state of a vehicle. In this embodiment, longer periods of time are to be taken as a basis for generating the decision recommendation in the data collection phase in order to have a statistical basis for the plausibility of the decision recommendation. Such an individualized decision recommendation increases the willingness of the driver and/or owner to retrofit the vehicle accordingly.

Further advantages and details of the present disclosure will become apparent from the following description of embodiments, the retrofitting of a motor vehicle with an automatically adjustable exterior mirror being provided for these embodiments.

In order to implement a usage-based recommendation logic for retrofitting a motor vehicle with a device (not just an automatically adjustable exterior mirror), the three phases or steps that should preferably be provided, are data collection phase, data processing phase with generation of a decision recommendation, and transmission and notification phase.

In the data collection phase, the driving behavior of a driver of the motor vehicle in question is recorded over a specific period of time or until sufficient data for subsequent data processing is available in order to be able to make a qualified statement. The following data can be recorded individually with the appropriate sensors:

Vehicle configuration: low-profile tires present (yes/no). The data source is a database (OEM backend) of the motor vehicle manufacturer, the key for access is the vehicle identification number VIN. It is important to state whether low-profile tires are present because the rim width or rim diameter is relatively high for low-profile tires and the risk of damage to the rim is significantly increased when driving against a curb.

Location, number and type of parking operations, including on-street parking or parking in a garage. The data source is formed by the position data of a GPS device installed on the motor vehicle or an application installed on the smartphone of the driver in question, the smartphone being coupled to the on-board computer system via the on-board WLAN or via Bluetooth.

Distinction between parallel vs. diagonal position of the vehicle during the parking operation. The data source comes from the vehicle, specifically the detection of the steering pattern before and during parking and/or additional information about which type of parking (parallel vs. diagonal parking) is available at the relevant location based on the specification of the location.

Information on the use of manual mirror adjustment. This data source is only available if electrically adjustable mirrors are installed. If such electrically adjustable mirrors are installed, this information can be called up by the ECU, i.e., the on-board computer.

Recording and classification of sounds related to wheel rim scratches on a curb. These records are correlated with the location according to the time stamp in each case. As a result, in the subsequent “data processing with recommendation generation” phase, the driver, and optionally also other drivers of other motor vehicles who have subscribed to a service, can be informed that their position corresponds to that of previous wheel rim damage.

In the data processing phase with generation of a decision recommendation, the recorded data is preferably sent to an external server (backend), where the next technical step, data processing with recommendation generation, takes place. However, taking data protection regulations into account, it may be advisable to store and process vehicle data directly in each vehicle and to only send the results of the data processing or the output of the usage-based recommendation logic to an external server. In such a situation, an algorithm implemented in the usage-based recommendation logic would generate a decision recommendation that runs locally on the relevant motor vehicle or another personal electronic device owned or operated by a driver. The transfer/transmission of the data, be it the entirety of the data recorded in the data collection phase or the specific decision recommendation, can be carried out using a method that is disclosed, for example, in the published patent application DE 10 2012 012 635A1 entitled “Method for transmitting at least one individual setting of a motor vehicle to a server”.

The notification of the driver and/or owner with a concrete decision recommendation for retrofitting the vehicle in question with a device, in this case with an automatic mirror adjustment system, can be made in an object-related manner on a display of the motor vehicle. This should preferably take place at a time when the driver or owner will not be disturbed, for example when starting a journey, i.e., before starting the engine or at the end of a journey, immediately after switching off the engine. Personal information, i.e., addressed directly to the driver or owner, is also possible. The contact details of the owner are known from a concluded sales contract; the contact details of the driver could also be known if the driver logs in at the start of the journey.

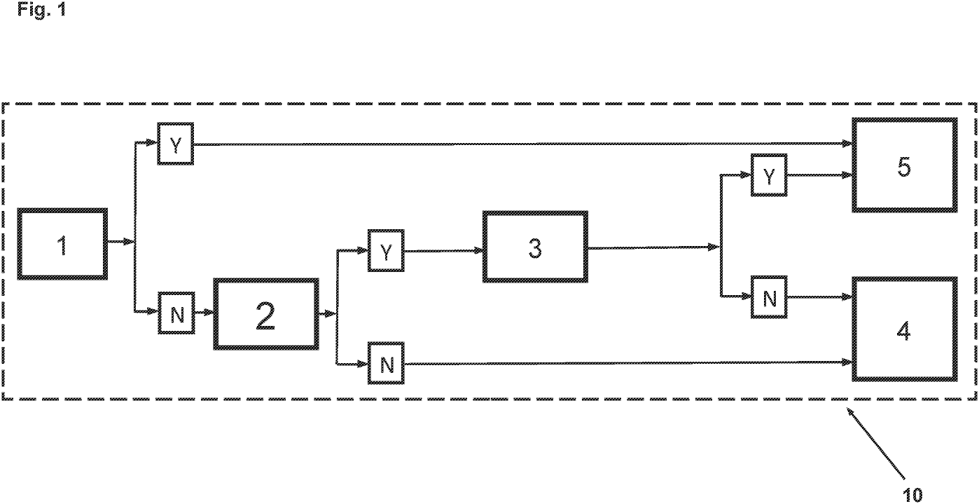

The functionality of the usage-based recommendation logic 10 is explained with reference to FIG. 1. For retrofitting a vehicle with an automatic mirror system, it is initially assumed that the vehicle in question is not equipped with an automatic mirror system. Firstly, it is stated that for the branches in blocks 1, 2 and 3, the corresponding two outputs are labeled Y (= yes) and N (= no).

It is now of particular importance whether the driver in question uses a manual exterior mirror adjustment at all. It is assumed that this manual adjustment is carried out electrically via an actuating element which is connected to the on-board computer. This detection is made in block 1 of the recommendation logic 10. The mere fact that this adjustment has been performed manually is sufficient to generate a decision recommendation 5 for retrofitting.

If the exterior mirrors are not adjusted manually, block 2 checks whether the vehicle in question is equipped with low-profile tires. This is relevant because of the greater damage potential. If there are no low-profile tires, there is no need to generate 4 a decision recommendation for retrofitting. A decision recommendation 5 aimed at the addressed persons (driver and/or owner) would be perceived as at least useless, if not even annoying.

If, on the other hand, low-profile tires are mounted on the motor vehicle in question, the next step in block 3 is to analyze the parking behavior, in particular whether parallel parking is being undertaken. For this purpose, the number of such parallel parking operations is counted beforehand in the data detection phase and set in relation to a threshold. The threshold can be an absolute number or a number related to a specific period of time. If this threshold is exceeded, a decision recommendation 5 for retrofitting is generated. If this threshold is not reached, no decision recommendation 4 is generated.

LIST OF REFERENCE SIGNS AND ACRONYMS USED

| | |
|---|---|
| 1 | Detection of a manual exterior mirror adjustment |
| 2 | Detection of whether the vehicle is equipped with wide-base tires |
| 3 | Detection of parallel parking on a street |
| 4 | No decision recommendation No generation of a decision recommendation for retrofitting |
| 5 | Decision recommendation Generation of a decision recommendation for retrofitting |
| 10 | Usage-based recommendation logic |
| ECU | Engine control unit, engine control module; On-board computer |
| N | No |
| VIN | Vehicle identification number, e.g., according to ISO Standard 3779 |
| Y | Yes |

1-8. (canceled)

9. A usage-based recommendation logic system for retrofitting a motor vehicle with a device, the usage-based recommendation logic system comprising:
an interface configured to couple to an on-board computer system,
wherein the on-board computer system is configured to record usage-specific, drive-specific, and vehicle-specific data that relate to a function of the device, and
wherein the usage-specific, drive-specific, and vehicle-specific data is provided by a plurality of sensors coupled to the on-board computer system; and
processing logic coupled to the on-board computer system via the interface, the processing logic configured to:
evaluate the usage-specific, drive-specific, and vehicle-specific data using specified thresholds, and
generate, based on the evaluation, a decision recommendation for retrofitting with the device.

10. The usage-based recommendation logic system of claim 9, wherein:
the usage-specific, drive-specific, and vehicle-specific data are transmitted wirelessly to an external server system,
the processing logic is implemented in the external server system, and
the generated decision recommendation is transmitted to at least one of the motor vehicle, the owner or driver of the motor vehicle.

11. The usage-based recommendation logic system of claim 9, wherein
the processing logic is implemented in the on-board computer, and
the processing logic is further configured to cause the generated decision recommendation to be transmitted to at least one of a display in the motor vehicle, or the owner or driver of the motor vehicle.

12. The usage-based recommendation logic system of claim 9, wherein the processing logic is further configured to cause the generated decision recommendation to be transmitted to a mobile device of the vehicle owner or the driver of the motor vehicle.

13. The usage-based recommendation logic system of claim 10, wherein the processing logic is configured to be associated with three phases, the three phases being:
a data collection phase;
a data processing phase associated with the generation of the decision recommendation; and
a transmission and notification phase.

14. The usage-based recommendation logic system of claim 13, wherein the device is an automatically adjustable exterior mirror, and wherein:
the usage-specific and drive-specific data relate to a detection of manually set exterior mirror settings, and recording of a type, number and location of parking operations; and
the vehicle-specific data relate to vehicle identification and/or to a presence of low-profile tires.

15. The usage-based recommendation logic system of claim 13, wherein the drive-specific data relates to recording of sounds associated with wheel rim scratches on a curb and a time stamp corresponding to each recording.

16. The usage-based recommendation logic system of claim 13, wherein the device is a heatable, automatically adjustable exterior mirror.
